(19) United States
(12) Patent Application Publication
(10) Pub. No.: US 2011/0193816 A1
(43) Pub. Date: Aug. 11, 2011

(54) CAPACITANCE CHANGE DETECTING CIRCUIT

(75) Inventor: Hidehito Kitakado, Osaka-shi (JP)

(73) Assignee: Sharp Kabushiki Kaisha, Osaka-shi, Osaka (JP)

(21) Appl. No.: 12/998,312

(22) PCT Filed: Jun. 2, 2009
(86) PCT No.: PCT/JP2009/060040

§ 371 Date: Apr. 7, 2011

(30) Foreign Application Priority Data
Nov. 14, 2008 (JP) 2008-291794

(51) Int. Cl. G06F 3/044; G06F 3/038

(52) U.S. Cl. 345/174; 345/208

(57) ABSTRACT

In at least one embodiment, when a surface of a liquid crystal panel is pressed, the capacitance value of a variable capacitor changes. One electrode of the variable capacitor is connected to a voltage supply line to which a common voltage is applied, and the other electrode of the variable capacitor is connected to a gate electrode of a TFT. The TFT outputs a voltage generated according to the capacitance value of the variable capacitor. Another TFT is provided between a control voltage line to which a control voltage is applied and the gate electrode of the TFT. A gate electrode of the other TFT is connected to a row selection line. By providing the other TFT, a desired voltage is applied to the gate electrode of the TFT, whereby charge accumulated on the electrode is dissipated, enabling to prevent circuit malfunction. By reducing the load capacitance of the control voltage line, a change in capacitance can be detected with a high sensitivity. By this, a capacitance change detecting circuit is provided that can detect a change in capacitance with a high sensitivity without malfunction.

### TECHNICAL FIELD

The present invention relates to capacitance change detecting circuits that detect changes in electrostatic capacitance. The capacitance change detecting circuits of the present invention are formed in, for example, a display panel of an image display device, and are used in an application where a touch position on a display screen is detected, etc.

### BACKGROUND ART

In recent years, electronic devices that can be operated by touching a screen with a finger, a pen, etc., have become widely used. In addition, for a method of detecting a touch position on a display screen, a method is known in which a plurality of capacitance change detecting circuits are provided in a display panel to detect changes in electrostatic capacitance caused when a surface of the display panel is pressed with a finger, a pen, etc.

Patent Document 1 describes a liquid crystal display device including a capacitance change detecting circuit shown in FIG. 10. In the circuit shown in FIG. 10, when a surface of a liquid crystal panel is pressed, the capacitance value of a variable capacitor 91 changes, and correspondingly, a gate voltage of a TFT (Thin Film Transistor) 92 changes. Hence, a read current to be outputted from a source electrode of a TFT 93 when a high-level selection voltage Vsel is provided to a gate electrode of the TFT 93 changes according to the capacitance value of the variable capacitor 91. Therefore, by comparing an output voltage Vout outputted from the source electrode of the TFT 93 with a threshold value, it can be determined whether the liquid crystal panel has been pressed or not near the variable capacitor 91. Patent Document 1 also describes a capacitance change detecting circuit shown in FIG. 11. In the circuit shown in FIG. 11 is added a control wiring line connected to a gate electrode of a TFT 92, in order to apply a control voltage Vctrl to the gate electrode of the TFT 92.

Techniques related to the invention of the present application other than the above are described in Patent Documents 2 and 3. Patent Document 2 describes a method in which conductive protrusions are provided on a counter electrode of a display panel to detect an increase in leakage current flowing through a transistor when a counter substrate is pressed with a pen. Patent Document 3 describes a method in which a variable capacitor is formed by a pair of electrodes on substrates and a dielectric inserted between the electrodes, and by changing the electrical capacitance of the variable capacitor by physical or electrical force, an external input is detected.

### RELATED DOCUMENTS

### Patent Documents

[Patent Document 1] Japanese Laid-Open Patent Publication No. 2006-40289

[Patent Document 2] Japanese Laid-Open Patent Publication No. 9-80467

[Patent Document 3] Japanese Laid-Open Patent Publication No. 2004-295881

### SUMMARY OF THE INVENTION

### Problems to be Solved by the Invention

In the circuit shown in FIG. 10, the gate electrode of the TFT 92 is an isolated electrode which is electrically isolated from other portions. However, during a TFT fabrication process, charge may be accumulated on the gate electrode of the TFT 92 due to the influence of static electricity, etc. In addition, in the case in which complete isolation is not provided between the electrodes of the variable capacitor 91, when the electrodes of the variable capacitor 91 come close to each other or come into contact with each other, charge may move between the electrodes of the variable capacitor 91 and accordingly the charge having moved may be accumulated on the gate electrode of the TFT 92.

When charge is accumulated on the gate electrode of the TFT 92, the threshold voltage of the TFT 92 changes and the output voltage Vout also changes. Hence, the circuit shown in FIG. 10 may malfunction. To prevent the malfunction, it is desirable for a capacitance change detecting circuit to be able to control the gate voltage of a TFT connected to one electrode of a variable capacitor. In addition, when charge beyond a certain amount is accumulated on the gate electrode of the TFT 92 when the electrodes of the variable capacitor 91 come close to each other or come into contact with each other, a problem arises that, even after the distance between the electrodes of the variable capacitor 91 returns to its original, the TFT 92 is continuously placed in an ON state. To solve this problem, it is essential for a capacitance change detecting circuit to have the function of dissipating charge accumulated on a gate electrode of a TFT connected to one electrode of a variable capacitor.

In the circuit shown in FIG. 11, since the gate electrode of the TFT 92 is not an isolated electrode, the above-described problem does not occur. In this circuit, however, a control wiring line is connected to capacitance change detecting circuits of one row in the liquid crystal panel. Since many gate electrodes are connected to a single control wiring line, the load capacitance of the control wiring line is large. Hence, even if the capacitance value of the variable capacitor 91 is changed, the gate voltage of the TFT 92 changes only slightly. As a result, with the circuit shown in FIG. 11, it becomes difficult to detect a change in capacitance, thereby decreasing the sensitivity.

An object of the present invention is therefore to provide a capacitance change detecting circuit that can detect a change in capacitance with a high sensitivity without malfunction.

### MEANS FOR SOLVING THE PROBLEMS

According to a first aspect of the present invention, there is provided a capacitance change detecting circuit that detects a change in electrostatic capacitance, the capacitance change detecting circuit including: a variable capacitor connected, at its one electrode, to a voltage supply line; a detection transistor connected, at its gate electrode, to an other electrode of the variable capacitor and outputting an electrical signal generated according to a capacitance value of the variable capacitor; and a voltage application switching element provided between a control voltage line and the gate electrode of the detection transistor.

According to a second aspect of the present invention, in the first aspect of the present invention, while the voltage application switching element is in an ON state, a predetermined control voltage is applied to the control voltage line and after the voltage application switching element is changed to an OFF state, the gate electrode of the detection transistor maintains a floating state.

According to a third aspect of the present invention, in the first aspect of the present invention, the capacitance change detecting circuit further includes an output control switching element that switches whether to output the electrical signal or not, the output control switching element being provided in a path of a current passing through the detection transistor.

According to a fourth aspect of the present invention, there is provided an image display device that can detect a touch position on a display screen, the image display device including: a display panel including a plurality of pixel circuits and one or more capacitance change detecting circuits; and a control circuit for the display panel, wherein each capacitance change detecting circuit includes: a variable capacitor connected, at its one electrode, to a voltage supply line; a detection transistor connected, at its gate electrode, to an other electrode of the variable capacitor and outputting an electrical signal generated according to a capacitance value of the variable capacitor; and a voltage application switching element provided between a control voltage line and the gate electrode of the detection transistor.

According to a fifth aspect of the present invention, in the fourth aspect of the present invention, the display panel includes a plurality of capacitance change detecting circuits arranged in a row direction and a column direction, and gate electrodes of voltage application switching elements included in capacitance change detecting circuits arranged in a same row are connected to a common signal line.

### EFFECT OF THE INVENTION

According to the first aspect of the present invention, by providing a voltage application switching element between a control voltage line and a gate electrode of a detection transistor, a gate voltage of the detection transistor is suitably controlled to dissipate charge accumulated on the gate electrode of the detection transistor, enabling to prevent circuit malfunction. In addition, by electrically separating the control voltage line and the gate electrode of the detection transistor from each other using a voltage application transistor, the load capacitance of the control voltage line becomes smaller. Hence, when the capacitance value of a variable capacitor is changed, the gate voltage of the detection transistor greatly changes. Accordingly, a change in capacitance can be detected with a high sensitivity.

According to the second aspect of the present invention, by controlling the state of the voltage application switching element and applying a predetermined control voltage to the control voltage line, the gate voltage of the detection transistor is suitably controlled, enabling to detect a change in capacitance.

According to the third aspect of the present invention, by providing an output control switching element in a path of a current passing through the detection transistor, switching of whether to output an electrical signal or not from a capacitance change detecting circuit can be performed. By this, even when the detection transistor is not placed in a complete OFF state, the capacitance change detecting circuit can be prevented from outputting an unnecessary electrical signal.

According to the fourth aspect of the present invention, by using a capacitance change detecting circuit that can detect a change in capacitance with a high sensitivity without malfunction, an image display device can be configured that can detect a touch position on a display screen with a high sensitivity without malfunction.

According to the fifth aspect of the present invention, when capacitance change detecting circuits are arranged two-dimensionally, by connecting the gate electrodes of voltage application switching elements included in those capacitance change detecting circuits arranged in the same row to a common signal line, signal lines used to control the capacitance change detecting circuits can be reduced in number.

### BRIEF DESCRIPTION OF THE DRAWINGS

FIG. 1 is a block diagram showing a configuration of a liquid crystal display device including capacitance change detecting circuits according to a first embodiment of the present invention.

FIG. 2 is a circuit diagram of a capacitance change detecting circuit according to the first embodiment of the present invention.

FIG. 3 is a cross-sectional view showing a structure of a part of the capacitance change detecting circuit shown in FIG. 2.

FIG. 4 is a characteristic diagram of the capacitance change detecting circuit shown in FIG. 2.

FIG. 5 is a characteristic diagram of the capacitance change detecting circuit shown in FIG. 2.

FIG. 6 is a block diagram showing a configuration of a liquid crystal display device including capacitance change detecting circuits according to a second embodiment of the present invention.

FIG. 7 is a circuit diagram of a capacitance change detecting circuit according to the second embodiment of the present invention.

FIG. 8 is a circuit diagram of a capacitance change detecting circuit according to a variant of the second embodiment of the present invention.

FIG. 9A is a circuit diagram of a capacitance change detecting circuit and a pixel circuit shown in FIG. 6.

FIG. 9B is a circuit diagram of circuits (first example) in which the number of signal lines is reduced over the circuits shown in FIG. 9A.

FIG. 9C is a circuit diagram of a second example with a reduced number of signal lines.

FIG. 9D is a circuit diagram of a third example with a reduced number of signal lines.

FIG. 9E is a circuit diagram of a fourth example with a reduced number of signal lines.

FIG. 9F is a circuit diagram of a fifth example with a reduced number of signal lines.

FIG. 9G is a circuit diagram of a sixth example with a reduced number of signal lines.

FIG. 9H is a circuit diagram of a seventh example with a reduced number of signal lines.

FIG. 10 is a circuit diagram of a conventional capacitance change detecting circuit.

FIG. 11 is a circuit diagram of a conventional capacitance change detecting circuit.

### MODE FOR CARRYING OUT THE INVENTION

### First Embodiment

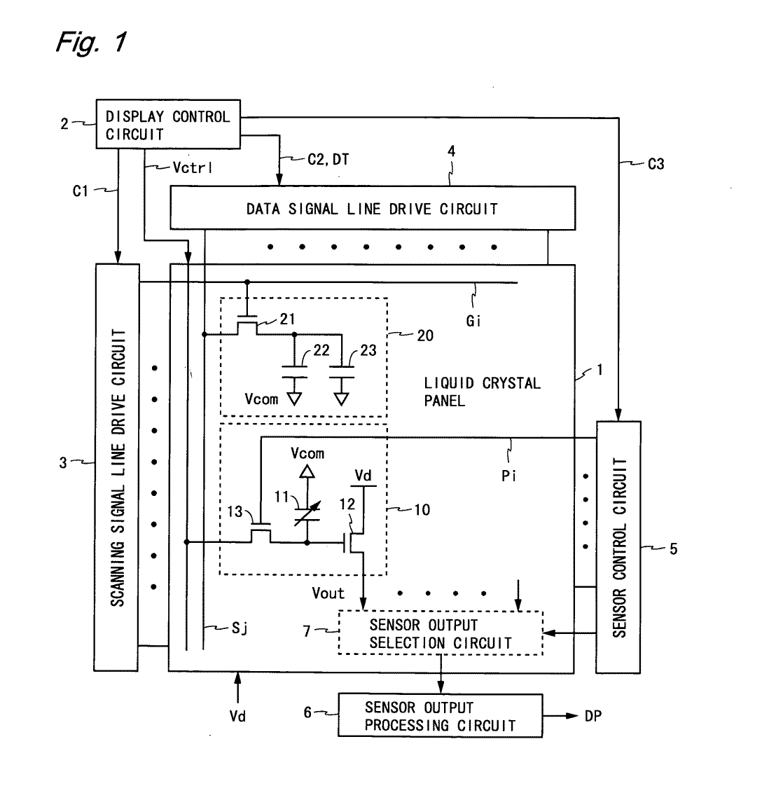

FIG. 1 is a block diagram showing a configuration of a liquid crystal display device including capacitance change detecting circuits according to a first embodiment of the present invention. The liquid crystal display device shown in FIG. 1 includes a liquid crystal panel 1, a display control circuit 2, a scanning signal line drive circuit 3, a data signal line drive circuit 4, a sensor control circuit 5, and a sensor output processing circuit 6. Capacitance change detecting circuits 10 according to the present embodiment are formed in the liquid crystal panel 1 together with pixel circuits 20, and detect changes in electrostatic capacitance caused when a surface of the liquid crystal panel 1 is pressed.

The liquid crystal panel 1 has a structure in which a liquid crystal material is sandwiched between two glass substrates. In the liquid crystal panel 1 are provided a plurality of scanning signal lines Gi parallel to one another; and a plurality of data signal lines Sj parallel to one another and intersecting perpendicularly with the scanning signal lines Gi. The pixel circuits 20 are provided near the respective intersections of the scanning signal lines Gi and the data signal lines Sj . A scanning signal line Gi is connected to those pixel circuits 20 arranged in the same row, and a data signal line Sj is connected to those pixel circuits 20 arranged in the same column. The capacitance change detecting circuits 10 are provided in association with the respective pixel circuits 20. In addition, row selection lines Pi of the same number as the scanning signal lines Gi are provided in parallel with the scanning signal lines Gi. A row selection line Pi is connected to those capacitance change detecting circuits 10 arranged in the same row. A sensor output selection circuit 7 that selects any of the outputs from the capacitance change detecting circuits 10 is also provided in the liquid crystal panel 1.

Each pixel circuit 20 includes a TFT 21, a liquid crystal capacitance 22, and an auxiliary capacitance 23. The TFT 21 is an N-channel type MOS transistor. A gate electrode of the TFT 21 is connected to one scanning signal line Gi, a source electrode of the TFT 21 is connected to one data signal line Sj, and a drain electrode of the TFT 21 is connected to one electrode of each of the liquid crystal capacitance 22 and the auxiliary capacitance 23. The other electrode (counter electrode) of each of the liquid crystal capacitance 22 and the auxiliary capacitance 23 is connected to a voltage supply line (not shown) to which a common voltage Vcom is applied.

The display control circuit 2, the scanning signal line drive circuit 3, the data signal line drive circuit 4, and the sensor control circuit 5 are control circuits for the liquid crystal panel 1. The display control circuit 2 outputs a control signal C1 to the scanning signal line drive circuit 3, and outputs a control signal C2 and a video signal DT to the data signal line drive circuit 4. In addition, the display control circuit 2 outputs a control signal C3 to the sensor control circuit 5, and supplies a control voltage Vctrl to the liquid crystal panel 1.

The scanning signal line drive circuit 3 selects any one of the plurality of scanning signal lines Gi according to the control signal C1, and applies a gate-on voltage (a voltage that places TFTs in an ON state) to the selected scanning signal line. The data signal line drive circuit 4 applies, according to the control signal C2, voltages generated according to the video signal DT to the data signal lines Sj . By this, pixel circuits 20 of one row are selected and voltages generated according to the video signal DT are written into the selected pixel circuits, whereby a desired image can be displayed.

The sensor control circuit 5 selects one of the plurality of row selection lines Pi according to the control signal C3, and applies a gate-on voltage to the selected row selection line. In addition, the sensor control circuit 5 controls the sensor output selection circuit 7 according to the control signal C3. The sensor output selection circuit 7 selects one or more signals from among output signals from the plurality of capacitance change detecting circuits 10, according to control by the sensor control circuit 5 and outputs the selected signal(s) to the outside of the liquid crystal panel 1. The sensor output processing circuit 6 obtains position data DP representing a touch position on a display screen, based on the signal(s) outputted from the liquid crystal panel 1.

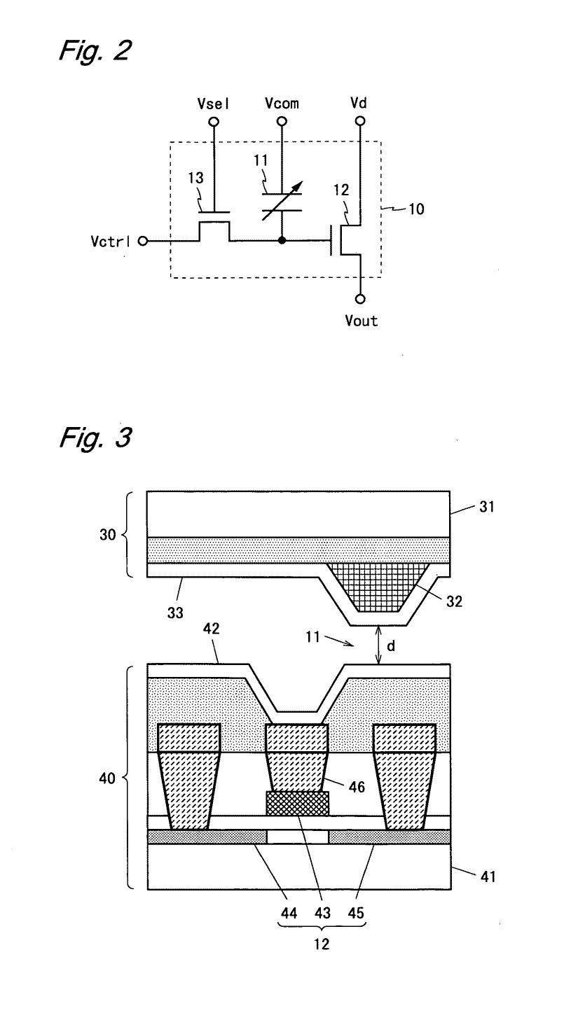

FIG. 2 is a circuit diagram of a capacitance change detecting circuit 10. As shown in FIG. 2, the capacitance change detecting circuit 10 includes a variable capacitor 11, TFTs 12 and 13. The TFTs 12 and 13 are N-channel type MOS transistors. One electrode of the variable capacitor 11 is connected to a voltage supply line to which a common voltage Vcom is applied, and the other electrode of the variable capacitor 11 is connected to a gate electrode of the TFT 12. A drain voltage Vd supplied from the outside of the liquid crystal panel 1 is applied to a drain electrode of the TFT 12. An output voltage Vout is outputted from a source electrode of the TFT 12. A gate electrode of the TFT 13 is connected to a row selection line Pi to which a selection voltage Vsel is applied. One of the other two electrodes of the TFT 13 is connected to a control voltage line to which a control voltage Vctrl is applied, and the other electrode is connected to the gate electrode of the TFT 12. The TFT 12 functions as a detection transistor that outputs an electrical signal generated according to the capacitance value of the variable capacitor 11. The TFT 13 functions as a voltage application switching element provided between the control voltage line and the gate electrode of the TFT 12.

FIG. 3 is a cross-sectional view showing a structure of a part of the capacitance change detecting circuit 10. FIG. 3 depicts a counter substrate 30 having a counter electrode 33 formed on a glass substrate 31; and a TFT-side substrate 40 having TFTs 12, etc., formed on a glass substrate 41. A protrusion 32 is provided on one side of the counter substrate 30 (the side facing the TFT-side substrate 40; the lower side in FIG. 3), on top of which is deposited ITO (Indium Tin Oxide), thereby forming the counter electrode 33. Various circuits are formed on one side of the TFT-side substrate 40 (the side facing the counter substrate 30; the upper side in FIG. 3), on top of which is deposited ITO, thereby forming a pixel electrode and a variable capacitance electrode 42. The counter substrate 30 and the TFT-side substrate 40 are arranged facing each other, and a liquid crystal material (not shown) is filled between the two substrates. By this, a liquid crystal capacitance 22 and a variable capacitor 11 are formed.

In a portion where the protrusion 32 is provided, the distance between the counter electrode 33 and the variable capacitance electrode 42 is shorter than that in other portions. In this portion, the variable capacitor 11 is formed. A portion of the counter electrode 33 where the protrusion 32 is provided serves as one electrode of the variable capacitor 11 (an electrode to which a common voltage Vcom is applied). A portion of the variable capacitance electrode 42 facing the portion where the protrusion 32 is provided serves as the other electrode of the variable capacitor 11. The variable capacitance electrode 42 is separated from the pixel electrode.

In the TFT-side substrate 40, a TFT 12 having a gate electrode 43, a source electrode 44, and a drain electrode 45 is formed near the variable capacitor 11. The gate electrode 43 is electrically connected to the other electrode of the variable capacitor 11 through a contact 46. A common voltage Vcom is applied to the counter electrode 33. When, in this state, a surface of the counter substrate 30 is pressed with a finger, a pen, etc., the counter substrate 30 approaches the TFT-side substrate 40, reducing the distance between the electrodes of the variable capacitor 11 (a distance d shown in FIG. 3). When the distance d between the electrodes changes, the capacitance value of the variable capacitor 11 changes. Correspondingly, the gate voltage of the TFT 12 changes and the output voltage Vout also changes. Therefore, by comparing the output voltage Vout with a threshold value, it can be determined whether the liquid crystal panel 1 has been pressed or not near the variable capacitor 11.

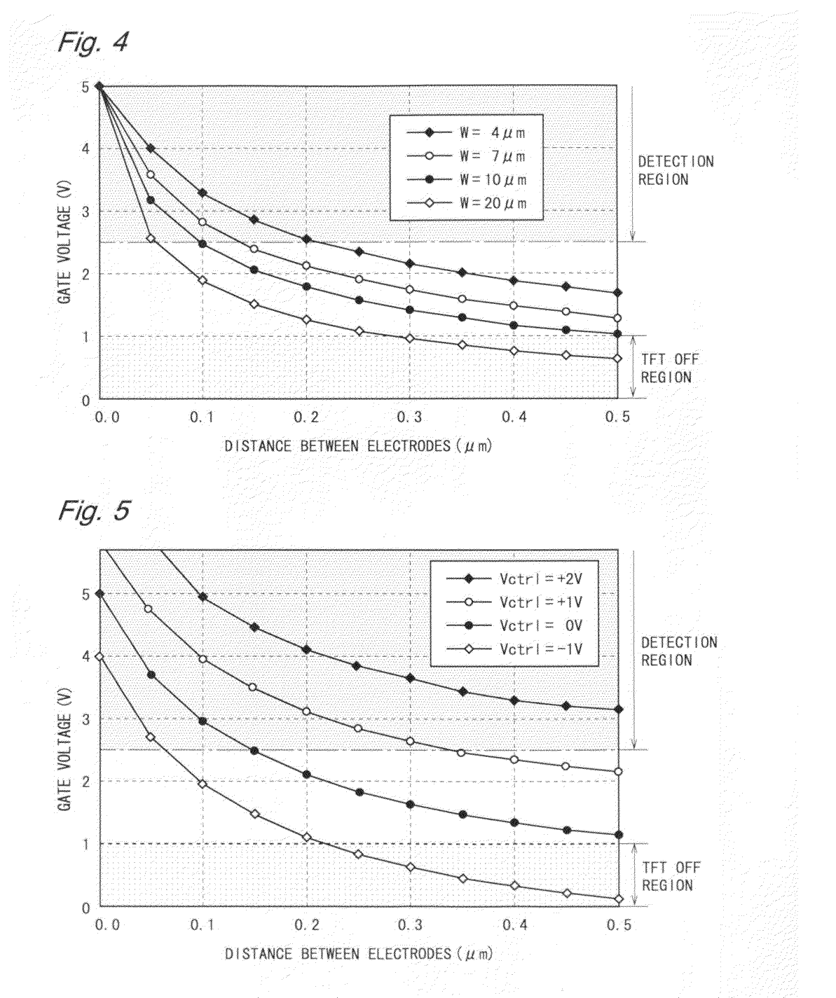

FIG. 4 is a characteristic diagram of the capacitance change detecting circuit 10. FIG. 4 depicts relationships between the distance d between the electrodes of the variable capacitor 11 and the gate voltage Vg of the TFT 12, with the common voltage Vcom being a direct current of 5 V and the channel width W of the TFT 12 being changed. As shown in FIG. 4, the smaller the distance d between the electrodes is, the higher the gate voltage Vg becomes. When the distance d between the electrodes is 0, the gate voltage Vg is equal to a common voltage of 5 V. In addition, the narrower the channel width W is, the higher the gate voltage Vg becomes.

The N-channel type TFT 12 is placed in an ON state when the gate voltage Vg is greater than or equal to a threshold voltage. However, when the gate voltage Vg is near the threshold voltage, the amount of read current flowing through the TFT 12 is small, and thus, it takes time for the output voltage Vout to change. Hence, a boundary voltage Vb higher than the threshold voltage is set and it is determined that there is a change in capacitance (i.e., the liquid crystal panel 1 has been pressed), when the gate voltage Vg is greater than or equal to the boundary voltage Vb. Here, the threshold voltage of the TFT 12 is 1 V and the boundary voltage Vb is 2.5 V. FIG. 4 depicts a range (a TFT OFF region) in which the gate voltage Vg is less than or equal to the threshold voltage, and a range (a detection region) in which the gate voltage Vg is greater than or equal to the boundary voltage. Note that 2.5 V is an example of the boundary voltage Vb and the boundary voltage Vb is arbitrarily determined according to the application, etc.

As shown in FIG. 4, when the channel width W is 4 μm, if the distance d between the electrodes becomes less than or equal to about 0.2 μm, then it is determined that there is a change in capacitance. On the other hand, when the channel width W is 20 μm, if the distance d between the electrodes becomes less than or equal to about 0.05 μm, then it is determined that there is a change in capacitance. As such, the sensitivity of the capacitance change detecting circuit 10 changes according to the channel width W of the TFT 12. The channel width W of the TFT 12 is arbitrarily determined according to the application, etc.

FIG. 5 is a diagram showing the same relationships as those shown in FIG. 4, with a gate-on voltage being applied to the gate electrode of the TFT 13 and the control voltage Vctrl being changed. The characteristics shown in FIG. 5 are obtained for a capacitance change detecting circuit 10 shown below. The electrodes of a variable capacitor 11 are 4×4 μm in size. The distance d between the electrodes of the variable capacitor 11 changes between 0 μm and 0.5 μm. The dielectric coefficient of the liquid crystal is 4 for an amount ε (//) in a direction parallel to the long axis of the liquid crystal, and is 7 for an amount ε (⊥) in a direction perpendicular to the long axis of the liquid crystal. The channel width and channel length of TFTs 12 and 13 are both 4 μm, and the thickness of gate insulating films of the TFTs 12 and 13 is 80 nm.

As shown in FIG. 5, when the control voltage Vctrl is +2 V, as long as the distance d between the electrodes is 0.5 μm or less, it is always determined that there is a change in capacitance. When the control voltage Vctrl is +1 V, if the distance d between the electrodes becomes less than or equal to about 0.35 μm, then it is determined that there is a change in capacitance. The conditions for determining that there is a change in capacitance when the control voltage Vctrl is changed to 0 V and −1 V change such that the distance d between the electrodes is about 0.15 μm or less and about 0.06 μm or less. By thus changing the control voltage Vctrl, the gate voltage of the TFT 12 is suitably controlled, enabling to adjust the sensitivity of the capacitance change detecting circuit 10.

The operation of the capacitance change detecting circuit 10 will be described below. In the following description, it is assumed that the common voltage Vcom is a direct current of 5 V, the control voltage Vctrl is 0 V, the threshold voltage Vth of the TFT 12 is 1 V, the initial value of the output voltage Vout is 0 V, and the initial value of the distance d between the electrodes of the variable capacitor 11 is 0.5 μm. In addition, the capacitance change detecting circuit 10 has the characteristics shown in FIG. 5, and the voltage that places TFTs in an OFF state is referred to as a gate-off voltage.

First, a gate-on voltage (e.g., 5 V) is applied to the gate electrode of the TFT 13. At this time, the TFT 13 is placed in an ON state and a control voltage of 0 V applied to the control voltage line is applied to the gate electrode of the TFT 12 through the TFT 13. Since a control voltage of 0 V is lower than a threshold voltage of 1 V of the TFT 12, the TFT 12 is placed in an OFF state regardless of the capacitance value of the variable capacitor 11. At this time, since the output voltage Vout does not change, even after the TFT 12 is placed in an OFF state, the output voltage Vout remains at 0 V.

Then, a gate-off voltage (e.g., 0 V) is applied to the gate electrode of the TFT 13. At this time, the TFT 13 is placed in an OFF state and the gate electrode of the TFT 12 is placed in a floating state. If, at this time, the distance d between the electrodes of the variable capacitor 11 has an initial value of 0.5 μm, then the gate voltage Vg of the TFT 12 is about 1 V (see FIG. 5). The output voltage Vout remains at about 0 V.

When a surface of the counter substrate 30 is pressed with a finger, a pen, etc., the distance d between the electrodes of the variable capacitor 11 decreases. At this time, the capacitance value of the variable capacitor 11 increases and thus the gate voltage Vg of the TFT 12 increases. For example, when the distance d between the electrodes is 0.1 μm, the gate voltage Vg of the TFT 12 is about 3 V. In addition, by Vout=Vg−Vth, the output voltage Vout is about 2 V. By comparing the output voltage Vout with the boundary voltage Vb, taking into account the threshold voltage Vth of the TFT 12, it is determined that there is a change in capacitance.

As such, in the capacitance change detecting circuit 10, by controlling the TFT 13 to an ON state, a control voltage Vctrl is applied to the gate electrode of the TFT 12, and by controlling the TFT 13 to an OFF state, the gate electrode of the TFT 12 can be set to a floating state. By this, even if charge is accumulated on the gate electrode of the TFT 12 in a floating state, when the TFT 13 is controlled to an on state, the charge accumulated on the gate electrode of the TFT 12 is dissipated, and thus, the gate voltage of the TFT 12 can be made equal to the control voltage Vctrl. Hence, even in the case in which charge is accumulated on a gate terminal of a TFT 12 during a TFT fabrication process or the case in which charge having moved from a counter electrode 33 is accumulated on a gate terminal of a TFT 12 when used, the gate voltage of the TFT 12 is not affected by such charge. Therefore, according to the capacitance change detecting circuit 10, circuit malfunction can be prevented.

In addition, by electrically separating the control voltage line and the gate electrode of the TFT 12 from each other using the TFT 13, the load capacitance of the control voltage line becomes smaller than that for the conventional circuit shown in FIG. 11. Hence, when the capacitance value of the variable capacitor 11 is changed, the gate voltage of the TFT 12 greatly changes. Therefore, according to the capacitance change detecting circuit 10 according to the present embodiment, a change in capacitance caused when the surface of the liquid crystal panel 1 is pressed can be detected with a high sensitivity.

As described above, according to a capacitance change detecting circuit 10 according to the present embodiment, by applying a control voltage Vctrl to a gate electrode of a TFT 12 through a TFT 13, a change in capacitance can be detected with a high sensitivity without malfunction. In addition, by using the capacitance change detecting circuit 10, an image display device can be configured that can detect a touch position on a display screen with a high sensitivity without malfunction. In addition, when capacitance change detecting circuits 10 are arranged two-dimensionally, by connecting the gate electrodes of TFTs 13 included in those capacitance change detecting circuits 10 arranged in the same row to a common row selection line Pi, signal lines used to control the capacitance change detecting circuits 10 can be reduced in number.

### Second Embodiment

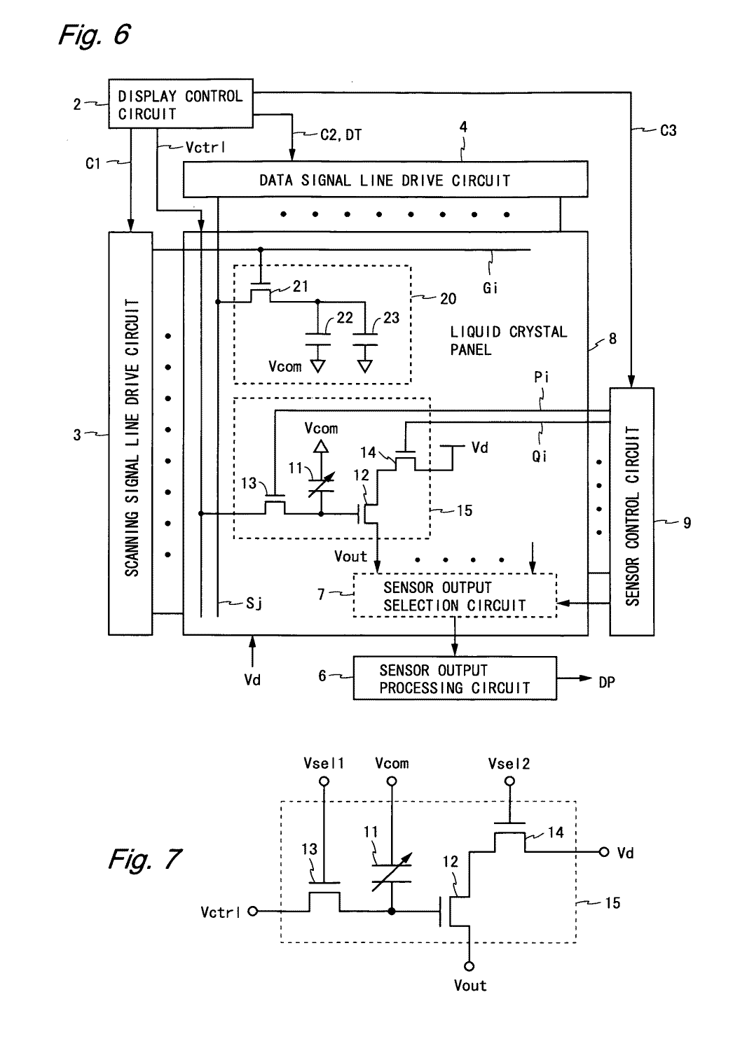

FIG. 6 is a block diagram showing a configuration of a liquid crystal display device including capacitance change detecting circuits according to a second embodiment of the present invention. The liquid crystal display device shown in FIG. 6 is such that in a liquid crystal display device according to the first embodiment (FIG. 1) a liquid crystal panel 1 and a sensor control circuit 5 are replaced by a liquid crystal panel 8 and a sensor control circuit 9. Capacitance change detecting circuits 15 according to the present embodiment are formed in the liquid crystal panel 8 together with pixel circuits 20, and detect changes in electrostatic capacitance caused when a surface of the liquid crystal panel 8 is pressed. Note that of the components in the present embodiment the same components as those in the first embodiment are denoted by the same reference numerals and description thereof is omitted.

As with the liquid crystal panel 1, in the liquid crystal panel 8 are provided a plurality of scanning signal lines Gi, a plurality of data signal lines Sj , a plurality of row selection lines Pi (hereinafter, referred to as the first row selection lines Pi), a plurality of pixel circuits 20, a plurality of capacitance change detecting circuits 15, and a sensor output selection circuit 7. In addition to them, in the liquid crystal panel 8, second row selection lines Qi of the same number as the first row selection lines Pi are provided in parallel with the first row selection lines Pi. As with the first row selection lines Pi, a second row selection line Qi is connected to those capacitance change detecting circuits 15 arranged in the same row.

As with the sensor control circuit 5, the sensor control circuit 9 selects a first row selection line Pi according to a control signal C3 and controls the sensor output selection circuit 7. In addition, the sensor control circuit 9 selects one of the plurality of second row selection lines Qi according to the control signal C3, and applies a gate-on voltage to the selected second row selection line. The sensor control circuit 9 selects the first row selection line Pi and the second row selection line Qi at different timings.

FIG. 7 is a circuit diagram of a capacitance change detecting circuit 15. The capacitance change detecting circuit 15 shown in FIG. 7 is such that a TFT 14 is added to a capacitance change detecting circuit 10 according to the first embodiment (FIG. 2). The TFT 14 is an N-channel type MOS transistor. In the capacitance change detecting circuit 15, a gate electrode of a TFT 13 is connected to a first row selection line Pi to which a first row selection voltage Vsel1 is applied. A drain electrode of a TFT 12 is connected to a source electrode of the TFT 14. A gate electrode of the TFT 14 is connected to a second row selection line Qi to which a second row selection voltage Vsel2 is applied. A drain voltage Vd supplied from the outside of the liquid crystal panel 8 is applied to a drain electrode of the TFT 14. The TFT 14 is provided in a path of a current passing through the TFT 12, and functions as an output control switching element that switches whether to output an output voltage Vout or not.

The TFT 14 is controlled to an ON state or an OFF state by the sensor control circuit 9. The capacitance change detecting circuit 15 outputs an output voltage Vout when the TFT 14 is in an ON state, and does not output an output voltage Vout when the TFT 14 is in an OFF state. As such, according to the capacitance change detecting circuit 15 according to the present embodiment, by providing the TFT 14 in the path of a current passing through the TFT 12, switching of whether to output an output voltage Vout or not can be performed.

For example, the case is considered in which, in a capacitance change detecting circuit having the characteristics shown in FIG. 5, the control voltage Vctrl is changed in a range of −4 V to +2 V. In this case, when the distance d between the electrodes is less than or equal to 0.1 μm, there is no chance that the TFT 12 is placed in a complete OFF state, regardless of the control voltage Vctrl. Hence, a leakage current flows through the TFT 12, increasing the power consumption of the capacitance change detecting circuit. According to the capacitance change detecting circuit 15 according to the present embodiment, even when the TFT 12 is thus not placed in a complete OFF state, a leakage current can be prevented from flowing through the TFT 12 and thus an unnecessary output voltage Vout can be prevented from being outputted.

In addition, in the capacitance change detecting circuit 15, according to the capacitance value of the variable capacitor 11 obtained when a control voltage Vctrl is applied to the gate electrode of the TFT 12, the gate voltage of the TFT 12 obtained when the capacitance value of the variable capacitor 11 changes thereafter changes. Therefore, by selecting a first row selection line Pi and a second row selection line Qi at different timings and performing application of a control voltage Vctrl and selection of capacitance change detecting circuits 15 at different timings, a constant relationship can be maintained at all times between the gate voltage of the TFT 12 and the capacitance value of the variable capacitor 11.

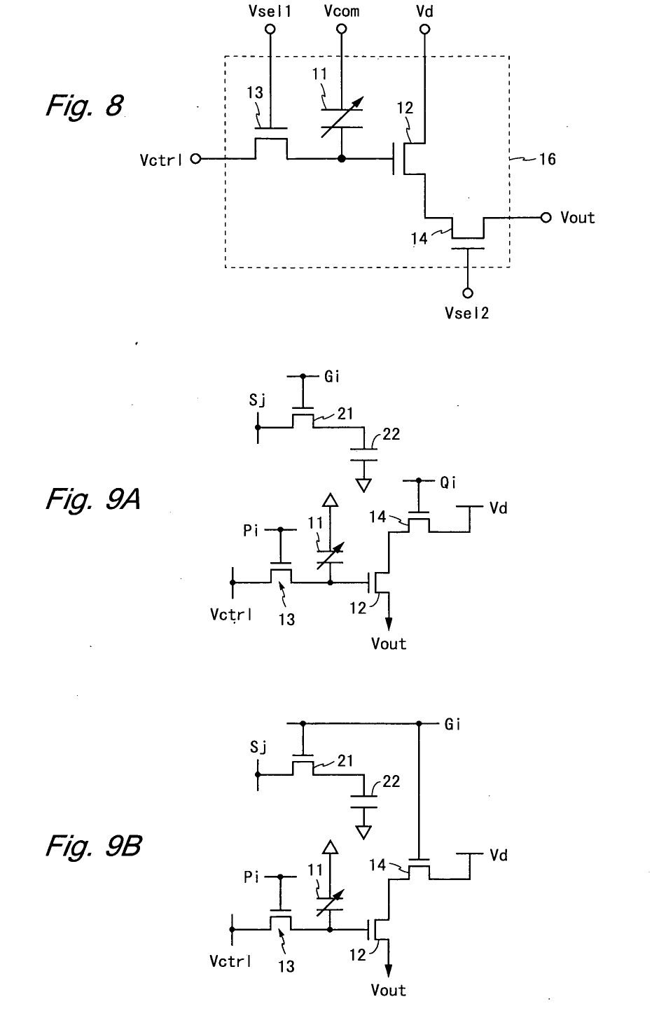

Note that, although, in the capacitance change detecting circuit 15 shown in FIG. 7, the TFT 14 is provided on the drain electrode side of the TFT 12, as shown in FIG. 8, a TFT 14 may be provided on the source electrode side of a TFT 12. In a capacitance change detecting circuit 16 shown in FIG. 8, a drain voltage Vd is applied to a drain electrode of the TFT 12, and a source electrode of the TFT 12 is connected to a drain electrode of the TFT 14. An output voltage Vout is outputted from a source electrode of the TFT 14. The capacitance change detecting circuit 16 according to this variant operates in the same manner as the capacitance change detecting circuit 15 and provides the same effects.

Note also that although, in the above description, in a liquid crystal panel a capacitance change detecting circuit is provided for every pixel circuit, in the liquid crystal panel any number of capacitance change detecting circuits may be provided in any form. For example, a capacitance change detecting circuit may be provided for every two or more pixel circuits, or a capacitance change detecting circuit may be provided only in a part of the liquid crystal panel, with no association with pixel circuits. In addition, in the liquid crystal panel, any type of wiring lines may be provided in any form as long as a necessary voltage can be supplied to the capacitance change detecting circuits and electrical signals outputted from the capacitance change detecting circuits can be outputted to the outside of the liquid crystal panel. In addition, the common voltage Vcom may be a direct-current voltage or an alternating-current voltage.

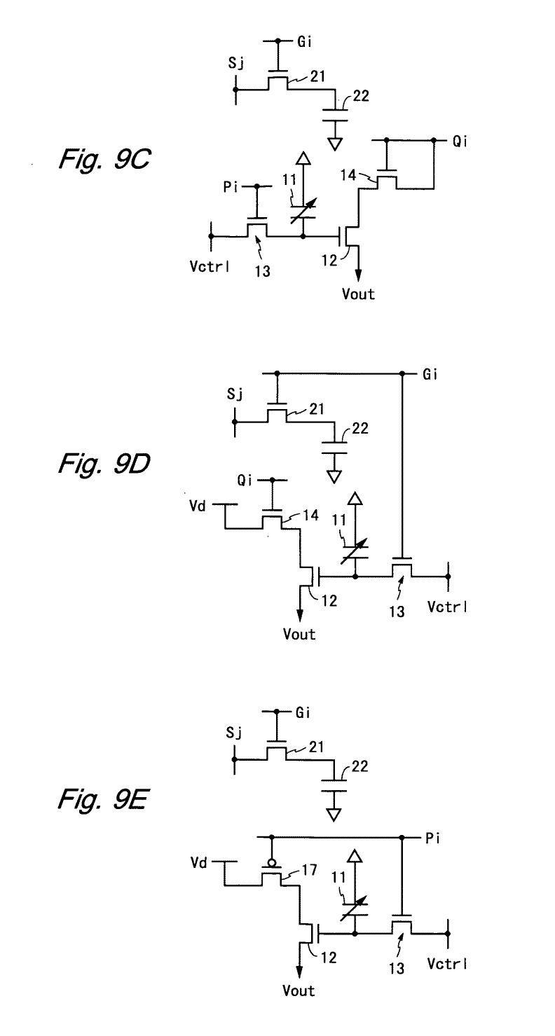

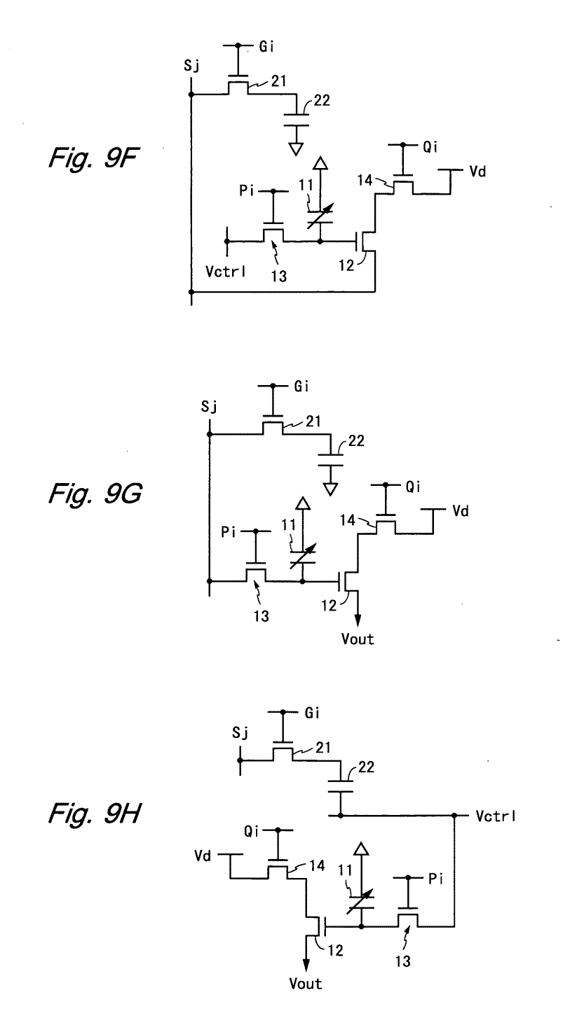

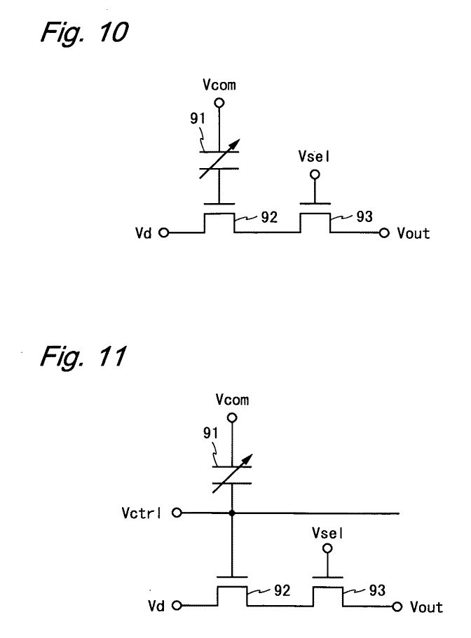

Note also that, when the terminal of a TFT in a pixel circuit and the terminals of TFTs in a capacitance change detecting circuit are all independent of one another, by sharing signal lines by connecting different terminals to the same signal line, the number of signal lines provided in the liquid crystal panel can be reduced. FIG. 9A is a circuit diagram of a capacitance change detecting circuit 15 and a pixel circuit 20 shown in FIG. 6 (note that an auxiliary capacitance 23 is excluded). For these circuits, the number of signal lines provided in the liquid crystal panel can be reduced by seven methods illustrated below.

First, as shown in FIG. 9B, a gate electrode of an output control switching element (a TFT 14) and a gate electrode of a write switching element (a TFT 21) in a pixel circuit may be connected to the same signal line (a scanning signal line Gi). Alternatively, as shown in FIG. 9C, the gate and drain electrodes of an output control switching element (a TFT 14) may be connected to the same signal line (a second row selection line Qi). Alternatively, as shown in FIG. 9D, a gate electrode of a voltage application switching element (a TFT 13) and a gate electrode of a write switching element (a TFT 21) may be connected to the same signal line (a scanning signal line Gi). Alternatively, as shown in FIG. 9E, a gate electrode of a voltage application switching element (a TFT 13) and a gate electrode of an output control switching element (a TFT 17) may be connected to the same signal line (a first row selection line Pi). Note, however, that in this case a P-channel type TFT 17 is used.

Alternatively, as shown in FIG. 9F, a source electrode of a detection transistor (a TFT 12) and a source electrode of a write switching element (a TFT 21) may be connected to the same signal line (a data signal line Sj). Alternatively, as shown in FIG. 9G, one electrode of a voltage application switching element (a TFT 13) and a source electrode of a write switching element (a TFT 21) maybe connected to the same signal line (a data signal line Sj). Alternatively, as shown in FIG. 9H, one electrode of a voltage application switching element (a TFT 13) and a common electrode of a liquid crystal capacitance 22 maybe connected to the same signal line (a control voltage line to which a control voltage Vctrl is applied). In addition, by suitably combining the above-described seven methods, the number of signal lines provided in the liquid crystal panel can be further reduced.

### INDUSTRIAL APPLICABILITY

Capacitance change detecting circuits of the present invention have features such as the ability to detect changes in capacitance with a high sensitivity without malfunction. Thus, the capacitance change detecting circuits can be used in various applications where changes in capacitance are detected, such as an application where a touch position on a display screen is detected in an image display device.

### DESCRIPTION OF REFERENCE NUMERALS

1 and 8: LIQUID CRYSTAL PANEL

2: DISPLAY CONTROL CIRCUIT

3: SCANNING SIGNAL LINE DRIVE CIRCUIT

4: DATA SIGNAL LINE DRIVE CIRCUIT

5 and 9: SENSOR CONTROL CIRCUIT

6: SENSOR OUTPUT PROCESSING CIRCUIT

7: SENSOR OUTPUT SELECTION CIRCUIT

10, 15, and 16: CAPACITANCE CHANGE DETECTING CIRCUIT

11: VARIABLE CAPACITOR

12 to 14 and 17: TFT

20: PIXEL CIRCUIT

30: COUNTER SUBSTRATE

31 and 41: GLASS SUBSTRATE

32: PROTRUSION

33: COUNTER ELECTRODE

34: INSULATING FILM

40: TFT-SIDE SUBSTRATE

42: VARIABLE CAPACITANCE ELECTRODE

43: GATE ELECTRODE

1. A capacitance change detecting circuit that detects a change in electrostatic capacitance, the capacitance change detecting circuit comprising:
a variable capacitor connected, at its one electrode, to a voltage supply line;
a detection transistor connected, at its gate electrode, to an other electrode of the variable capacitor and outputting an electrical signal generated according to a capacitance value of the variable capacitor; and
a voltage application switching element provided between a control voltage line and the gate electrode of the detection transistor.

2. The capacitance change detecting circuit according to claim 1, wherein while the voltage application switching element is in an ON state, a predetermined control voltage is applied to the control voltage line and after the voltage application switching element is changed to an OFF state, the gate electrode of the detection transistor maintains a floating state.

3. The capacitance change detecting circuit according to claim 1, further comprising an output control switching element that switches whether to output the electrical signal or not, the output control switching element being provided in a path of a current passing through the detection transistor.

4. An image display device that can detect a touch position on a display screen, the image display device comprising:
a display panel including a plurality of pixel circuits and one or more capacitance change detecting circuits; and
a control circuit for the display panel, wherein each capacitance change detecting circuit includes:
a variable capacitor connected, at its one electrode, to a voltage supply line;
a detection transistor connected, at its gate electrode, to an other electrode of the variable capacitor and outputting an electrical signal generated according to a capacitance value of the variable capacitor; and
a voltage application switching element provided between a control voltage line and the gate electrode of the detection transistor.

5. The image display device according to claim 4, wherein
the display panel includes a plurality of capacitance change detecting circuits arranged in a row direction and a column direction, and
gate electrodes of voltage application switching elements included in capacitance change detecting circuits arranged in a same row are connected to a common signal line.
